(19) United States
(12) Patent Application Publication
(10) Pub. No.: US 2004/0036052 A1
(43) Pub. Date: Feb. 26, 2004

(54) Ball valve

(75) Inventors: Martin Nowak, Burscheid (DE); Rolf Lappan, Koln (DE); Dirk Hunkel, Aachen (DE); Peter Haushalter, Monchengladbach (DE)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: Pierburg GmbH

(21) Appl. No.: 10/644,271

(22) Filed: Aug. 20, 2003

(30) Foreign Application Priority Data
Aug. 22, 2002 (DE) 102 38 478.9

(51) Int. Cl. F16K 5/20

(52) U.S. Cl. 251/314

(57) ABSTRACT

A ball valve particularly suitable for fuel aggregates comprises an outlet channel (12,14) and at least one inlet channel (16). Between the outlet channel (12,14) and the inlet channel (16), a switching element (20) is provided. A sealing element (24,26) contacts the switching element (20). In order to increase the sealing effect, the sealing element (24,26) comprises two sealing lips (28,30) each of which contacts the switching element (20) on a circular line.

### BACKGROUND OF THE INVENTION

### Field of the Invention

The invention relates to a ball valve for fuel aggregates that are particularly used in motor vehicles. The ball valve according to the invention is particularly suitable for highly liquid media, particularly highly liquid gases, i.e., media with very small molecules.

Fuel aggregates for motor vehicles comprise a fuel cell in which electric energy is produced, typically while using hydrogen and oxygen. If necessary, a reformer precedes the fuel cell. By means of the reformer, hydrogen can be produced from conventional fuels such as gasoline, diesel oil or methanol, which is then supplied to the fuel cell. Because of the preceding reformer, fuel aggregates can be used in motor vehicles without an extensive supply of hydrogen being necessary. Between the reformer and the fuel cell and between a hydrogen tank and the fuel cell, respectively, controllable valves are generally required to be able to supply the appropriate amount of oxygen and hydrogen to the fuel cell.

With fuel aggregates, it is required that the used valves are able to extremely tightly seal a flow channel or the like. This is required, for example, when hydrogen is used since even mixtures of hydrogen and air with small portions of hydrogen may explode. Further, very high tightnesses of the valves are required since hydrogen is a highly liquid gas, i.e., a gas with very small molecules.

### SUMMARY OF THE INVENTION

It is the object of the invention to provide a ball valve for fuel aggregates by means of which a very high tightness can be achieved.

This object is solved, according to the invention, with the features of claim 1.

The ball valve according to the invention comprises at least one inlet channel and at least one outlet channel. The valve according to the invention may be a 2-2-way valve or a 2-3-way valve. Between the inlet channel and the outlet channel, a substantially spherical switching element is arranged, the inlet channel being able to be connected to the outlet channel, for example, or the connection between two channels being able to be interrupted or a switching to two other channels being able to be performed by turning the switching element. Furthermore, at least one sealing element contacts the switching element to ensure an as tight sealing of the channel as possible, particularly in the closed state. Typically, a valve comprising several inlet channels, for example, comprises one sealing element per inlet channel.

According to the invention, the sealing element comprises two sealing lips respectively contacting the switching element along a circular line. Hence, the sealing element according to the invention is a spherical double seal. Because of the provision of two sealing lips, a high degree of tightness can be achieved.

Compared with conventional sealing elements, such as sealing rings from PTFE, the two-lip sealing element according to the invention has the advantage that a high bias force is required with such sealing rings to ensure a reliable sealing, particularly with highly liquid media. This further results in a high adjusting force as well.

Preferably, an annular recess open toward the switching element is provided between the two sealing lips. Preferably, the two sealing lips extend parallel to each other here. Providing an annular recess between the two sealing lips has the advantage that the sealing lips are able to be pressed against the switching element. In doing so, the mutual distance of the two sealing lips may slightly change, particularly get larger. Because of the increased pressing force, the tightness of the sealing element is further improved.

At least one of the two sealing lips comprises a pressing surface preferably pointing toward a channel, particularly an inlet channel, so that pressure appearing at the driving surface increases the pressing force of the sealing lip against the switching element and thus further improves the sealing effect.

To ensure a reliable sealing of the ball valve according to the invention in any operational state, i.e., also in a state in which no or only a low pressure appears at the sealing, the sealing element according to the invention preferably comprises a foot part, a head part and a web part connecting the foot part with the head part. The foot part is preferably arranged in the housing and particularly serves to retain and define the position of the sealing element in the housing, respectively. The sealing lips are connected with the head part. The web part, which is tapered with respect to the foot part and the head part, represents an elastic connection between the head part and the foot part. Due to this elasticity, the assembly dimensions can be selected such that the web part is elastically deformed in the assembled state and the sealing lips thus always press against the switching element with a predefined force. Preferably, the foot part, the head part and/or the web part are annular.

### BRIEF DESCRIPTION OF THE DRAWINGS

Hereinafter, the invention will be described in detail with respect to a preferred embodiment with reference to the accompanying drawings.

In the Figures:

FIG. 1 shows a schematic sectional view of a ball valve according to the invention, and

FIG. 2 shows a schematic enlargement of the portion II in FIG. 1.

### DETAILED DESCRIPTION OF THE PREFERRED EMBODIMENT OF THE INVENTION

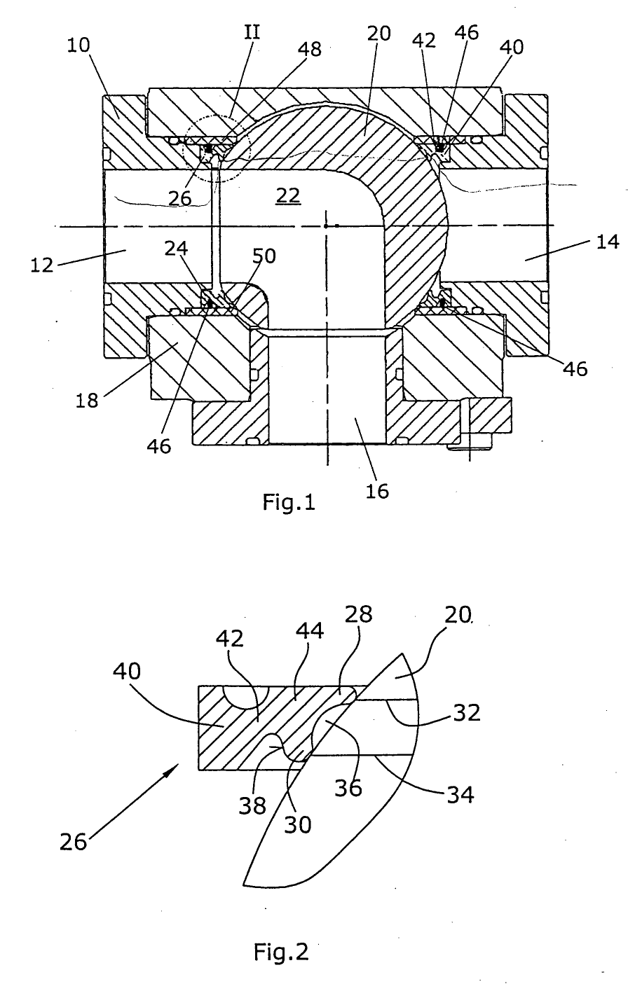

In a housing 18, an outlet channel 12, an outlet channel 14 and an inlet channel 16 are provided. Via an intermediate portion or a sleeve 10, the inlet channel 16 is connected with the housing 18. Within the housing 18, a substantially spherical switching element 20 is arranged. In the state illustrated in FIG. 1, a medium flows through the inlet channel 16, through a channel 22 of the switching element 20 into the outlet channel 12.

For sealing the outlet channels 12,14 with respect to the switching element 20, sealing elements 24 and 26, respectively, are annularly provided. The sealing elements 24,26, which are preferably made of an elastomeric plastic material, comprise two annular sealing lips 28,30 (FIG. 2) each of which contacts the spherical switching element 20 along a circular line 32 and 34, respectively. By means of the two sealing lips 28,30 substantially extending parallel to each other, a double sealing is realized. Thereby, a small leakage is ensured.

Between the two sealing lips 28,30, an annular recess 36 is provided which is configured concavely in the illustrated embodiment. Thereby, the elasticity and movability of the sealing lips 28,30 is increased. Further, in case of increased forces appearing, the sealing lips 28,30 are adapted to be forced apart and thus achieve a higher sealing effect. Here, the two sealing lips 28,30 are arranged at such an angle to the spherical switching element 20 that the two sealing lips 28,30 are forced apart when the pressing force is increased.

In the illustrated embodiment, the outlet channel 14 is closed so that an increased pressure appears at a portion of the sealing elements 26 and 24. This results in that the inner sealing lip 30 is pressed against the switching element. To this end, the sealing lip 30 has a pressing surface 38 for increasing the tightness, which points towards the inlet channel 16.

To ensure a bias, i.e., a reliable pressing of the sealing lips 28,30 in any state, the sealing element 24,26 has a foot part 40, a web part 42 and a head part 44. The web part 42, which has a considerably smaller cross section in comparison with the foot part 40 and the head part 44, is configured so as to be elastic. Thereby, a good transmission of force and thus a bias of the sealing lips 28,30 can be achieved. The configuration of the sealing elements 24,26 as an annular foot part 40, an annular head part 44 and an annular web 42 causes that the sealing element 24,26 acts as a soft spring. Due to this relatively slight but tight pressing of the sealing lips 28,30 against the switching element 20, a small frictional force with respect to the rotational axis and thus a small torque for adjusting the switching element 20 is required.

Furthermore, a clamping ring 46 arranged between the head part 40 and the foot part 44 is provided in the housing 18 for retaining or fixing the position of the sealing elements 24,26, respectively.

Furthermore, a stop element or stop ring 48 and 50, respectively, is provided. By the stop ring 48,50, which is also arranged within the housing 18, the maximum displaceability of the switching element 20 in axial direction is restricted.

It is particularly preferred to integrally form the clamping ring 46 together with the sealing element 24 and 26, respectively, and/or together with the stop element 50. Another preferred variant consists in that the sealing element 24 and 26, respectively, is formed integrally with the clamping ring 46 from a relatively soft elastomeric plastic material and that the stop element or stop ring is made from a plastic material with low friction, such as PTFE.

The assembly of the sealing elements 24,26, the clamping rings 46 as well as the stop element 48,50 is effected before the sleeve 10 or a sleeve opposite thereto are screwed in.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A ball valve for fuel aggregates, comprising
at least one outlet channel,
at least one inlet channel,
a substantially spherical switching element arranged between the inlet channel and the outlet channel, the inlet channel being able to be connected with the outlet channel or a connection being able to be interrupted by actuating the switching element, and
a sealing element contacting the switching element, characterized in that
the sealing element comprises two sealing lips each of which contacts the switching element along a circular line.

2. The ball valve according to claim 1, characterized in that an annular recess open toward the switching element is provided between the two sealing lips.

3. The ball valve according to claim 1 or 2, characterized in that at least one sealing lip has a pressing surface so that the sealing effect is improved when pressure appears.

4. The ball valve according to claim 1, characterized in that the sealing element comprises a foot part for being arranged in a housing, a head part comprising the sealing lips, and an elastic web part connecting the foot part with the head part.

5. The ball valve according to claim 1, characterized by a stop element for restricting the axial displaceability of the switching element.

6. The ball valve according to claim 1, characterized by a clamping ring for fixing the position of the sealing element in the housing.

7. The ball valve according to claim 1, characterized in that the clamping ring and/or the sealing element and/or the stop element are integrally formed.
